(19) United States
(12) Patent Application Publication
(10) Pub. No.: US 2025/0380680 A1
(43) Pub. Date: Dec. 18, 2025

(54) RETRACTABLE VENTING TOOL

(71) Applicants: Jesse B. Hunt, Tierra Verde, FL (US); Joshua K. Rimmer, Lakeland, FL (US); Brandon L. Zotter, Vero Beach, FL (US)

(72) Inventors: Jesse B. Hunt, Tierra Verde, FL (US); Joshua K. Rimmer, Lakeland, FL (US); Brandon L. Zotter, Vero Beach, FL (US)

(21) Appl. No.: 19/239,634

(22) Filed: Jun. 16, 2025

Related U.S. Application Data
(60) Provisional application No. 63/660,378, filed on Jun. 14, 2024.

(51) Int. Cl. A01K 99/00; A22C 25/00

(52) U.S. Cl. CPC A01K 99/00; A22C 25/006

(57) ABSTRACT

A Retractable Venting Tool has a needle with a point and an opposite shank, a knob connecting to the needle proximate the shank, a barrel receiving the needle and a primary slot guiding passage of the knob, a front spring near the tip, a rear spring away from the primary slot, and a clip outside of the barrel. The barrel has ridges outward of the primary slot, a shoulder outward of the ridges, and a head opposite the tip. The front spring compresses upon advancing the knob and needle outwardly from the tip. Upon completion of venting of a fish and turning the knob, the front spring retracts the needle abruptly. The rear spring compresses upon the knob being furthest from the tip. Before venting a fish, the rear spring imparts an axial force to the needle and cooperating with the knob retains the needle inside the barrel until needed.

### CROSS-REFERENCE TO RELATED APPLICATION

This non-provisional application claims priority to the pending provisional application Ser. No. 63/660,378 filed on Jun. 14, 2024 and all applications are owned by the same inventors.

### BACKGROUND OF THE INVENTION

The present invention relates to fishing tackle. More particularly, the invention retracts instantaneously following venting of a fish of the deep sea while remaining stored until its usage.

From the beginning when things were dark over the waters of the Earth, fish have proliferated. Fish swim along the coasts, in the shallower waters, and in rivers, lakes, and oceans at all depths. Fish also swim in freshwater and in saltwater. Legions of fishermen have sought to catch fish for millennia. Through that time, fish have remained wily thus calling for fishermen to stay on top of things and keep up their game. Fishermen, whether recreational or commercial, seek fish where they may be found. The bigger fish though take more prey and food to support them and they thus seek bigger and deeper water. The bigger fish also go deeper to avoid their own predators.

Let us turn to the fish of the deep sea, which live below where man swims. The fish of the deep sea live themselves in the darkness and pressure at great depths. Light itself does not reach where these fish live and the pressure there would crush most anything made by man. But the fish of the deep sea still attract fishermen. Tuna swim below one hundred fifty feet deep. Blue marlin go down to three hundred feet deep. And a snailfish swims along at 27,000 feet deep. At those depths, fish have anatomical features for their survival. The fish have larger eyes to see, and swim bladders and other features to survive high pressure. The swim bladders allow the fish to ascend to lower depths and to descend to greater depths. The swim bladders and other features allow the fish to avoid the “bends,” or decompression sickness. A fish does draw oxygen from the nearby water and then releases carbon dioxide from its gills. The presence of those gases in the fish's gills and then bloodstream raises the prospect of the bends.

Fishermen though still seek fish of the deep sea. Fishermen use their tackle and lines of wide description to seek the fish way down below the fishing boat. Commercial and recreational fishermen have expressed concern about their fisheries where some released fish at the surface that do not survive. Some released fish perish due to foul hooking, such as hooking the fish in the stomach or throat, injuries caused by barotrauma, that is, injury due to expansion of gas when reeled up from the deep sea, handling damage, stress from the fishing process, and predation. Barotrauma has recently attracted attention from fishermen and fisheries managers at all levels.

Barotrauma injures a fish when caused by the expansion of gas inside the fish from the rapid pressure decrease that occurs when a fish is retrieved from the deep sea or the bottom. Barotrauma generally occurs when retrieving fish from depths of 90 feet or more. It can also occur in waters as shallow as approximately 33 feet. Barotrauma results from internal gases that fill the abdomen at larger volume when at atmospheric pressure at the water's surface. The internal gases may cause the fish to lose the ability to swim back down to its normal living depth. Having caught a fish and reeled it to the surface, a fishermen may observe signs of barotrauma in a fish that include a distended abdomen, bulging eyes, an everted stomach, and bubbling under the scales. Releasing a fish in that condition may limit its future and jeopardize a fishery. Fish experiencing barotrauma often have a challenge swimming back to deeper waters. The ailing fish may also float on the water's surface, which makes them vulnerable to predation from dolphins, sharks and other fish, and seabirds.

Fishermen, biologists, ichthyologists, and fisheries managers have sought to lessen the fish lost at the surface to barotrauma. The search for techniques and tackle to promote survival of fish of the deep sea brought to the water's surface has gone far and wide. Throughout this application, where a masculine word or pronoun is used, the feminine word or pronoun is implied, as all are equal before fish, see generally Pres. Herbert Hoover, Florida Speaks, 1951.

### DESCRIPTION OF THE PRIOR ART

As there are other fish and many fish in the sea, various tackle, equipment, and techniques have appeared over the years to aid fish of the deep sea when brought to the surface. Fishermen have used the tools at their disposal, knives, awls, and ice picks, for millennia. The knife with its pointed tip readily punctures the scales of a fish but then slices more than the fish's skin. Awls and ice picks having pointed tips and elongated forms penetrate the scales of a fish but may continue further into the fish's viscera unless the fishermen has skill.

Knives, awls, and ice picks along with other prior art devices seek to penetrate the abdomen of a fish of the deep sea. In doing so, the prior art releases the excess gases accumulated in the body cavity of a fish when the fish is reeled in from the depths. Other prior art devices have sharpen, hollow instruments that allows air to escape, such as a hypodermic syringe but without its plunger. A hypodermic syringe though has its needle exposed following use to vent a fish of the deep sea. In the excitement of catching such a fish and bringing it on the boat, the fisherman just might stick himself with that exposed needle.

The prior art also follows select fisheries regulations issued by States, state agencies, federal agencies, and other regulators. One regulation sets a minimum size of a needle both in gauge and English measurements to properly vent fish of the deep sea.

While the above-described devices fulfill their respective particular objectives and requirements, the aforementioned devices do not describe a Retractable Venting Tool. Therefore, a need exists for new and improved Retractable Venting Tool that can be used for safe storage and then prompt venting of a fish of the deep sea upon its landing by a fisherman. In this regard, the present invention substantially fulfills this need. In this respect, the Retractable Venting Tool according to the present invention substantially departs from the conventional concepts and designs of the prior art, and in doing so provides a device primarily developed for the purpose of venting a fish of the deep sea with balanced biasing during usage and storage of the device.

The Retractable Venting Tool overcomes the above-mentioned disadvantages and drawbacks of the prior art. As such, the general purpose of the present invention, which will be described subsequently in greater detail, is to provide a new and improved Retractable Venting Tool which has all the advantages of the prior art mentioned heretofore and many novel features that result in hosiery which are not anticipated, rendered obvious, suggested, or even implied by the prior art, either alone or in any combination thereof.

### SUMMARY OF THE INVENTION

The Retractable Venting Tool has a needle with a point and an opposite shank, a knob connecting to the needle proximate the shank, a barrel receiving the needle and a primary slot guiding passage of the knob, a front spring near the tip, a rear spring away from the primary slot, and a clip outside of the barrel. The barrel has ridges outward of the primary slot, a shoulder outward of the ridges, and a head opposite the tip. The front spring compresses upon advancing the knob and needle outwardly from the tip. Upon completion of venting of a fish and turning the knob, the front spring retracts the needle abruptly. The rear spring compresses upon the knob being furthest from the tip. Before venting a fish, the rear spring imparts an axial force to the needle and cooperating with the knob retains the needle inside the barrel until needed.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved Retractable Venting Tool that provides prompt venting of a fish of the deep sea and safe storage before and after.

Another object of the present invention is to provide a Retractable Venting Tool that lessens inadvertent sticks and cuts to a fisherman using the Tool.

Another object of the present invention is to provide a Retractable Venting Tool that retracts its working needle promptly following venting.

Another object of the present invention is to provide a Retractable Venting Tool that retains its working needle within it until a fisherman desires its usage as upon landing a fish from the deep sea.

Another object of the present invention is to provide a Retractable Venting Tool that lessens the burdens, maintenance, jamming, and cleaning upon a fisherman.

Another object of the present invention is to provide a Retractable Venting Tool that has external surface features that promote a solid grip by a fisherman.

Another object of the present invention is to provide a Retractable Venting Tool that has a clip for storage in a pocket of a fisherman's vest, garment, wetsuit, or upon any edge useful by the fisherman.

Another object of the present invention is to provide a Retractable Venting Tool that minimizes the risk of injuries to a fisherman.

Another object of the present invention is to provide a Retractable Venting Tool that minimizes the risk of tears, cuts, abrupt distension, and death to a fish of the deep sea upon landing by a fisherman at the surface.

Another object of the present invention is to provide a Retractable Venting Tool that builds skill and confidence in the fisherman through its usage.

Another object of the present invention is to provide a Retractable Venting Tool that releases pressurized gases from a fish of the deep sea landed at the surface.

Another object of the present invention is to provide a Retractable Venting Tool that lessens sticks into the fisherman.

Another object of the present invention is to provide a Retractable Venting Tool that induces consistent inserting of its needle when guided by a fisherman during usage.

Another object of the present invention is to provide a Retractable Venting Tool that complies with fisheries regulations.

Another object of the present invention is to provide a new and improved Retractable Venting Tool that may be easily and efficiently manufactured and marketed to the consuming fishermen, charter operators, harvesters, biologists, ichthyologists, regulators, public, purchasing managers, buyers, and the like.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

In referring to the drawings,

FIG. 1 is a top view of the preferred embodiment of the present invention;

FIG. 2 is a bottom view of the invention;

FIG. 3 is a side view of the invention;

FIG. 4 is another side view of the invention;

FIG. 5 is a front view of the invention;

FIG. 6 is a back view of the invention;

FIG. 7 is a section view of the invention;

FIG. 8 is a side view of the invention with the needle of the invention deployed for usage;

FIG. 9 is a front view of the needle;

FIG. 10 is a side view of the needle; and

FIG. 11 is an exploded view of the invention.

The same reference numerals refer to the same parts throughout the various figures.

### DESCRIPTION OF THE PREFERRED EMBODIMENT

Referring now to the drawings, and particularly to FIGS. 1-11, a preferred embodiment of the Retractable Venting Tool of the present invention is shown by the reference numeral 1 in FIG. 1. The invention has an elongated, cylindrical, pen like form as shown in FIG. 1. The tool 1 has a barrel 20 of a hollow elongated form with its length at least four times the diameter. Towards the left of the figure, the barrel has a tip 22 of lesser diameter than the barrel and as an end of a truncated conical form. The tip in this embodiment has a rounded rim. The conical form serves as an instep 21 that expands in diameter from the tip to the barrel. The instep also has a round form to follow that of the barrel and a rounded ring like junction to the barrel. Opposite the instep, the barrel has a plurality of ridges 26, here at least three, that extend concentrically around the barrel and near each other. Outward from the ridges 26, the barrel has its shoulder 23 of a generally round from that also has an expanding conical portion as shown. The shoulder has a rounded ring at its end that transitions to a concave neck 24 that decreases in diameter to a minimum and then expands in diameter outwardly, or to the right in the figure. Extending outwardly from the neck 24, the barrel ends with a head 25. In the preferred embodiment, the head has a plurality of lengthwise knurling. In an alternate embodiment, head is smooth.

Returning to the barrel generally in the center of the figure, the tool 1 has a primary slot 30 along most of the barrel commencing near the ridges 26. The primary slot 30 appears on edge in this view. Proximate the ridges 26, the primary slot has an upper primary slot 31 with its width and length shorter than the primary slot 30 shown. The upper primary slot 31 is ninety degrees in rotation away from the primary slot. The upper primary slot has its opening shown. Opposite the upper primary slot towards the instep, the primary slot 30 has its lower primary slot 32. The lower primary slot 32 shown has its width the same as the upper primary slot 31 and its length shorter than the length of the upper primary slot 31. The lower primary slot 32 aligns with the upper primary slot 31. The lower primary slot 32, the primary slot 30, and the upper primary slot 31 communicate and allow passage of a knob 40. This figure shows the knob 40 out of the plane of the figure and near the ridges. The knob connects to a needle 2 partially shown within the upper primary slot 31. The knob and the needle attain a retracted position in this figure. The needle continues left, that is, towards the instep. Another portion of the needle 2 appears visible through the lower primary slot. To the left of the lower primary slot 32, a coil of a front spring 10 appears.

This figure shows the tool 1 in the retracted position as when a fishermen carries it in a pocket or a vest. To prevent unwanted advancement of the needle 2, as later shown in FIGS. 8, 9, the slot 30 has a secondary slot 33 downward in rotation from the upper primary slot 31. The secondary slot has a width akin to that of the primary slot and the shortest length of the slots 30, 31, 32. The secondary slot aligns with the primary slot as later shown in FIG. 3.

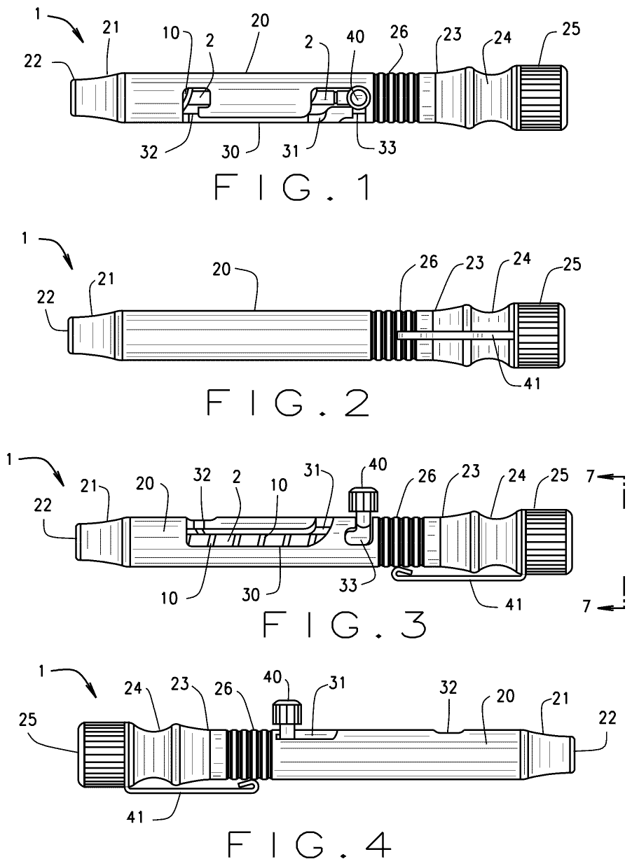

FIG. 2 then shows a bottom view of the invention 1 opposite that of FIG. 1. The invention 1 has the barrel 20, instep 21, tip 22, ridges 26, shoulder 23, neck 24, and head 25 as before. In this view the barrel does not show the slots of FIG. 1. Spanning from the neck 24 near its abutting of the head 25 along the ridges 26, the invention has a clip 41. The clip has a length sufficient for a fisherman to clasp the invention upon a shirt pocket, a vest pocket, or other edge during usage. As the clip 41 has a position opposite the slots, that orients the invention during nonusage so the knob 40 has its position against the fishermen's garment. The knob then imparts a haptic sensation to the fishermen who then knows the tool has its location in his pocket.

Turning the invention, FIG. 3 has the invention upon its side. The invention 1 has its barrel 20 with the instep 21 and the tip 22 as before. Opposite the tip 22, the barrel has the ridges 26, shoulder 23, neck 24, and head 25. The invention has the clip 41 extending from the head 25 over the neck 24 and the shoulder 23 and then contacting the ridges 26. The clip has its position opposite that of the knob 40 when the knob travels in the upper primary slot 31. Between the ridges 26 and the instep 21, the barrel 20 has its slots that permit the knob 40 to travel and move the needle from the retracted position shown to an advanced position later shown in FIG. 8. The knob travels from the secondary slot 33, that locks the knob in the retracted position into the upper primary slot 31, then down into the primary slot 30 for a sizeable length of the barrel, and then upwardly into the lower primary slot 32 here to the left of the figure.

The FIG. 3 shows the length of the primary slot 30 as an elongated opening in the barrel. Inward from the primary slot, the invention has its needle 2 within the coils of a front spring 10. This figure also shows the needle, even the invention, in the retraced position.

Rotating the tool one hundred eighty degrees from that of FIG. 3, FIG. 4 shows the opposite side view of the tool 1. As before, the invention has its head 25 here on the left, then its neck 24 from which the clip 41 extends, the shoulder 23, and the ridges 26 along which the clip ends. Opposite the ridges, the barrel 20 has the instep 21 tapering to the tip 22. The barrel has its round cylindrical form as before. The barrel then has an edge shown of the lower primary slot 32 inward form the instep and then an edge of the upper primary slot 31 nearing the ridges. In the retracted position, the knob 40 has its position in the upper primary slot 31 proximate the ridges. More particularly, the knob in this position shows the invention in a retraced, ready position where upon a fisherman releasing his thumb from the knob, the needle advances abruptly to that shown in FIG. 8.

Previous description has mentioned the retracted position of the invention and to be careful regarding the advanced position. FIG. 5 shows a front view of the invention, thankfully in the retracted position. The barrel 22 has its round form with the knob 40 shown toward the top center and the clip 41 with its narrow rectangular form at the bottom center of the figure. Between the knob and the clip, the barrel has the edge of the head 25 in the background as the head's diameter exceeds that of the barrel. Then the barrel has the instep 21 narrowing to the tip 22 in the center of the figure itself. Within the tip 22, the invention has its needle awaiting action once a fish of the deep sea reaches the fisherman.

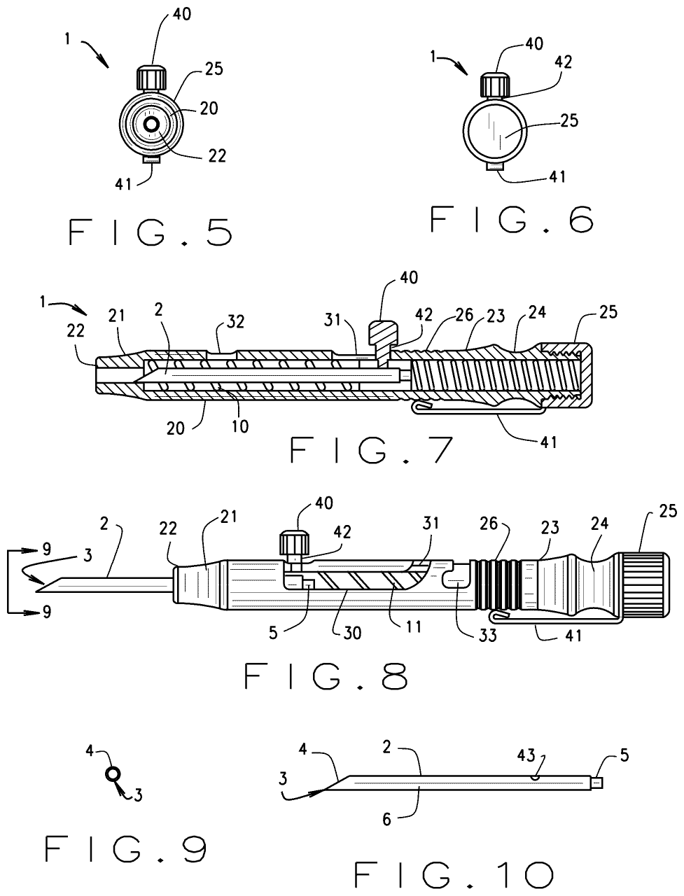

Rotating the invention again, FIG. 6 shows the back view of the invention 1 with the head 25 in the foreground. A fisherman would see this view as the invention rests in his pocket. The head has, away from it into the plane of the figure, the knob 40 extending radially outward when in the retraced ready position and the clip 41 opposite the knob.

The previous figures have referred to the needle 2 and a front spring 10 partially shown. FIG. 7 as a section view lengthwise of the invention shows the working of the invention. The invention has the barrel 20, instep 21, tip 22, ridges 26, shoulder 23, neck 24, and head 25 as before. This view provides further detail of their interior and additional components of the invention. The instep has a hollow passage through which the needle 2 passes. The barrel, ridges, shoulder, neck and head have a hollow, cylindrical construction to admit components of the invention as shown. The barrel 20 admits the front spring 10. In the retracted ready position shown, the front spring elongates and stays ready to provide a compressive force used by other components of the invention. The front spring spans from the instep towards the knob 40. The front spring on one end fixes to or connects to the barrel within the instep and the other end of the front spring connects to the knob. The needle 2 of the invention has its position centered within the front spring 10 and has its own out 3 proximate the instep 21 at the opening of the passage, awaiting action. The needle then has its long body 6 extending rearward from the point towards the knob 40. The knob 40 connects to a stem 42 that joins to the needle in a perpendicular orientation. Outward from the stem and the needle, the invention has a rear spring 11 here shown compressed. The rear spring on one end fixes to or connects to the barrel within the head and the other end of the rear spring connects to the needle proximate its shank, as later described. The rear spring imparts a tensile force against the needle so that the stem abuts the edge of the upper primary slot 31 and friction thus prevents the knob from rotating the stem and advancing the needle unless the fisherman pushes the knob intentionally. The front spring has its own k1 spring constant while the rear spring has its k2 spring constant generally of lesser magnitude than k1. The rear spring then extends from the needle into the head as shown. As above, the clip 41 has its position opposite the knob 40 shown in the figure. This figure also shows the head 25 being of a cap design that threadedly engages cooperating threads from the neck. In summary, the front spring compresses upon advancing the knob and needle outwardly from the tip. Upon completion of venting of a fish and turning the knob, the front spring retracts the needle abruptly. The rear spring compresses upon the knob being furthest from the tip. Before venting a fish, the rear spring imparts an axial force to the needle and cooperating with the knob retains the needle inside the barrel until needed.

With a fish on a boat and the fisherman at hand, FIG. 8 shows the tool 1 with the needle 2 advanced into the fish to release the internal gases. The gases initially created at depth by the fish expand under Boyle's law at the lower pressure of the surface and inflate the fish. As before, the tool has its barrel 20, with the tip 22, instep 21, ridges 26, shoulder 23, neck 24, head 25 and clip 41. The barrel also has it primary slot 30 its upper primary slot 31 and outward from that the secondary slot 33. This figure shows the advanced position of the invention where a fisherman has tapped the knob 40 so it rapidly enters the upper primary slot 31, then then primary slot 30, and the lower primary slot 32 as the front spring 10 retracts and abruptly advances the needle 2 outward of the tip 22. The needle 2 has an elongated tubular form with its own beveled end that narrows to a point 3. The point has sharpness and shape to penetrate the scales and skin of a fish of the deep sea during usage. Preferably the needle is at least 0.050 inch diameter. The needle has a length of at least five times its diameter. The beveled end of the needle has an angle from 30 degrees to 60 degrees from the longitudinal axis of the needle.

Then turning the needle as point first, FIG. 9 has what a fish sees just before use of the invention 1. The needle has its beveled end, see FIG. 8, that has an opening of a lumen 4 generally oval in shape. The bottom of the lumen comes together as the point 3 that penetrates the scales and skin of the fish allowing for entry of the hollow needle to evacuate internal gases from the fish and lessen barotrauma.

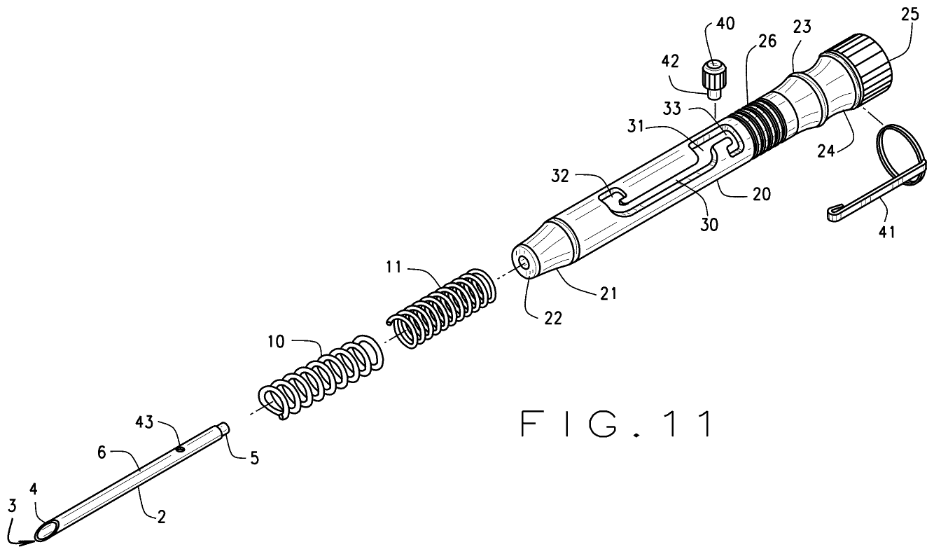

FIG. 10 then shows a side view of the needle with the point 3 on the left from the lumen 4. The lumen appears as the beveled end of the needle 2 at one end of the body 6 of the needle. The needle has a hollow, thin, elongated form suitable for passage of gas therethrough. Opposite the lumen, the body has a shank 5 that cooperates with the rear spring. In the preferred embodiment, the shank has a square cross section that mates with a similar aperture in a plate or other fixture of the rear spring. Slightly inward from the shank, the needle has a threaded aperture 43 that receives the stem 42 of the knob 40 previously shown. The knob through the stem threadedly engages the aperture. In an alternate embodiment, the threaded aperture extends in a radial direction into the needle.

And, FIG. 11 provides an exploded view of the invention 1. So from the left, the invention has its needle 2 with the point 3 of the lumen 4 and opposite the point a shank 5. The shank and the lumen define the limits of the body 6 of the needle. The body has the threaded aperture 43 near the shank that receives the stem 42 of the knob 40 here shown slight up from the needle. The front spring 10 then has a coaxial position with the needle as shown. Outward from the front spring, the invention has the rear spring 20. As before the front spring and the rear spring have their own spring constants, k, and elongation lengths suitable for their positions and functions within the invention. Outward from the rear spring, the tip 22 begins with the barrel 20 followed by the instep 21. The barrel has the lower primary slot 32 therein that communicates to the primary slot 30 along the length of the barrel back to the upper primary slot 31. Slightly outward from the upper primary slot, the barrel has the secondary slot 33 that holds the knob 40 in a rest position. The barrel continues away from the secondary slot with the ridges 26 to the shoulder 23, then the neck 24, and to the head 25. The clip 41 has its location in this figure downward from the neck 24 and along the ridges 26 parallel to the longitudinal axis of the barrel. As described above in FIG. 7, the head threadedly engages with the neck, thus securing the rear spring 20, the front spring 10, and the needle 2 with the invention though may move during usage and storage.

While a preferred embodiment of the Retractable Venting Tool has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. The Retractable Venting Tool may have polymer, metal, stainless steel, composite, or another variety of hybrid material may be used in any of the invention's components. The invention has a construction of a sturdy, lightweight material that resists saltwater, ultraviolet light, ice, and other aquatic hazards.

Although providing a Retractable Venting Tool, it should be appreciated that the Retractable Venting Tool herein described is also suitable for a variety of fish, other deep sea creatures known to science, and the deep sea creatures yet unseen.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Various aspects of the illustrative embodiments have been described using terms commonly employed by those skilled in the art to convey the substance of their work to others skilled in the art. However, it will be apparent to those skilled in the art that the present invention may be practiced with only some of the aspects described. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like-when they appear—are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

We claim:

1. A device to vent a fish by a fisherman, comprising:
a hollow needle, said needle having a point adapted to penetrate a fish;
a barrel receiving said needle;
said needle passing within at least one spring, said at least one spring positioning within said barrel;
wherein a fisherman places said barrel upon a fish who then releases said needle under action of said at least one spring and said point of said needle then penetrates a fish evacuating internal gases therefrom; and
wherein said device retracts said needle during non-usage.

2. The device to vent a fish by a fisherman of claim 1 further comprising:
said barrel having a hollow, elongated, cylindrical from, a tip upon one end of said barrel, an instep inwardly from said tip, a head opposite said tip, a neck inwardly from said head, a shoulder inwardly from said neck, and a plurality of ridges inwardly of said shoulder, and a longitudinal axis; and
a primary slot opening into said barrel parallel to the longitudinal axis, said primary slot guiding passage of said needle.

3. The device to vent a fish by a fisherman of claim 2 further comprising:
a clip extending from said head to said plurality of ridges outwardly of said barrel.

4. The device to vent a fish by a fisherman of claim 2 further comprising:
said at least one spring including a front spring and a rear spring;
said front spring positioning within said barrel proximate said instep and extending along said primary slot;
said rear spring positioning within said barrel proximate said head and extending interiorly of said ridges;
said front spring biasing to release said needle into a fish during usage; and
said rear spring biasing to retract said needle following usage.

5. The device to vent a fish by a fisherman of claim 4 further comprising:
said needle having a point and an opposite shank;
said barrel having a head outwardly of said neck and opposite said needle;
a knob connecting to said needle away from said point, said knob cooperatively engaging said primary slot;
said front spring fixing to said barrel proximate said instep and to said shank wherein said front spring advances said needle abruptly when said knob enters said primary slot; and
said rear spring fixing to said head and to said shank.

6. The device to vent a fish by a fisherman of claim 5 further comprising:
said needle having a threaded aperture proximate said shank and said knob threadedly engaging said threaded aperture; and
said point of said needle widening to a lumen upon a bevel to the longitudinal axis.

7. The device to vent a fish by a fisherman of claim 6 further comprising:
a secondary slot spacing away from said primary slot towards said head; and
said knob operatively engaging said secondary slot.

8. The device to vent a fish by a fisherman of claim 7 further comprising:
a lower primary slot proximate said instep and communicating with said primary slot;
an upper primary slot spaced away from said lower primary slot and communicating with said primary slot;
said knob travelling through said secondary slot, said upper primary slot, said primary slot, and said lower primary slot during usage.

9. The device to vent a fish by a fisherman of claim 8 further comprising:
said device having a rest position with said knob resting in said secondary slot wherein said device is stored and transported, a retracted position with said knob held in said upper primary slot wherein said device is prepared for use, and an advanced position with said knob entering said lower primary slot wherein said needle penetrates a fish.

10. A fish venting device comprising:
a barrel having a hollow, elongated, cylindrical form, a tip upon one end of said barrel, an instep inwardly from said tip, a head opposite said tip, a neck inwardly from said head, a shoulder inwardly from said neck, and a plurality of ridges inwardly of said shoulder, and a longitudinal axis;
a primary slot opening into said barrel parallel to the longitudinal axis, said primary slot locating between said plurality of ridges and said instep;
a front spring within said barrel proximate said instep and extending along said primary slot;
a rear spring within said barrel proximate said head and extending interiorly of said ridges;
a needle having a hollow, thin, elongated form, said needle having a point adapted to penetrate a fish, said needle passing within said front spring to a release position during usage and said needle retracting against said rear spring when not in usage;
a knob connecting to said needle away from said point, said knob cooperatively engaging said primary slot wherein said front spring advances said needle abruptly when said knob enters said primary slot; and
wherein said point of said needle then penetrates a fish evacuating internal gases therefrom.

11. The fish venting device of claim 10 further comprising:
a secondary slot spacing away from said primary slot towards said head; and
said knob operatively engaging said secondary slot.

12. The fish venting device of claim 11 further comprising:
a lower primary slot proximate said instep and communicating with said primary slot;
an upper primary slot spaced away from said lower primary slot and communicating with said primary slot;
said knob travelling through said secondary slot, said upper primary slot, said primary slot, and said lower primary slot during usage.

13. The fish venting device of claim 12 further comprising:
said front spring biasing to release said needle into a fish during usage; and
said rear spring biasing to retract said needle following usage.

14. The fish venting device of claim 13 further comprising:
said needle having a point and an opposite shank;
said barrel having a head outwardly of said neck and opposite said needle;
said front spring fixing to said barrel proximate said instep and to said shank wherein said front spring advances said needle abruptly when said knob enters said primary slot; and
said rear spring fixing to said head and to said shank.

15. The fish venting device of claim 14 further comprising:
said needle having a threaded aperture proximate said shank and said knob threadedly engaging said threaded aperture; and
said point of said needle widening to a lumen upon a bevel to the longitudinal axis.

16. The fish venting device of claim 12 further comprising:
said device having a rest position with said knob resting in said secondary slot wherein said device is stored and transported, a retracted position with said knob held in said upper primary slot wherein said device is prepared for use, and an advanced position with said knob entering said lower primary slot wherein said needle penetrates a fish.

17. The fish venting device of claim 10 further comprising:
a clip extending from said head to said plurality of ridges outwardly of said barrel.

18. A fish venting device comprising:
a needle having a hollow, thin, elongated form, said needle having a point adapted to penetrate a fish;
a barrel having a hollow, elongated, cylindrical form, a tip upon one end of said barrel, an instep inwardly from said tip, a head opposite said tip, a neck inwardly from said head, a shoulder inwardly from said neck, and a plurality of ridges inwardly of said shoulder, and a longitudinal axis;
a primary slot opening into said barrel parallel to the longitudinal axis, said primary slot locating between said plurality of ridges and said instep;
a front spring positioning within said barrel proximate said instep and extending along said primary slot, said front spring biasing to release said needle into a fish during usage;
a rear spring positioning within said barrel proximate said head and extending interiorly of said ridges, said rear spring biasing to retract said needle following usage;
said needle passing within said front spring to an advanced position during usage and said needle retracting against said rear spring when not in usage;
said needle having a point and an opposite shank;
said head being opposite said needle;
a knob connecting to said needle away from said point, said knob cooperatively engaging said primary slot;
said front spring fixing to said barrel proximate said instep and to said shank wherein said front spring advances said needle abruptly when said knob enters said primary slot;
said rear spring fixing to said head and to said shank wherein said rear spring retracts said needle after usage;
a secondary slot spacing away from said primary slot towards said head;
said knob operatively engaging said secondary slot;
a lower primary slot proximate said instep and communicating with said primary slot;
an upper primary slot spaced away from said lower primary slot and communicating with said primary slot; and
said knob travelling through said secondary slot, said upper primary slot, said primary slot, and said lower primary slot during usage.

19. The fish venting device of claim 18 further comprising:
said tip having a conical form;
said needle having a threaded radial aperture proximate said shank and said knob threadedly engaging said threaded radial aperture;
said point of said needle widening to a lumen upon a bevel to the longitudinal axis;
said device having a rest position with said knob resting in said secondary slot where said device is stored and transported, a retracted position with said knob held in said upper primary slot wherein said device is prepared for use, and an advanced position with said knob entering said lower primary slot wherein said device penetrates a fish.
